(19) United States
(12) Patent Application Publication
(10) Pub. No.: US 2013/0282612 A1
(43) Pub. Date: Oct. 24, 2013

(54) RETURN ON PARTNERSHIP INVESTMENT CALCULATOR

(71) Applicants: Gary Gust Spiros, Chagrin Falls, OH (US); Patricia Ann Genetin, Uniontown, OH (US); David Richard Knowles Griffiths, Lausanne (CH); Farouk Omar Al-Shorafa, Naples, FL (US)

(72) Inventors: Gary Gust Spiros, Chagrin Falls, OH (US); Patricia Ann Genetin, Uniontown, OH (US); David Richard Knowles Griffiths, Lausanne (CH); Farouk Omar Al-Shorafa, Naples, FL (US)

(73) Assignee: CA, Inc., Islandia, NY (US)

(21) Appl. No.: 13/450,981

(22) Filed: Apr. 19, 2012

(51) Int. Cl. G06Q 40/06

(52) U.S. Cl. 705/36 R

(57) ABSTRACT

Systems and methods for calculating a return on partnership investment are presented. An example system includes a first module to receive a reseller input representative of a cost related to a reseller selling a product of a selling partner and a cost assumption input representative of a cost related to buying the product from the selling partner, and generate a reseller output as a function of the reseller input, the reseller output related to a cost of the reseller. The system may further include a report module to receive the reseller output and the cost assumption input and to generate a report output as a function of the reseller output and cost assumption input, the report output comprising a return on partnership investment.

### BACKGROUND

Prior attempts at return on investment calculators do not calculate a return on investment of partnering with another entity to do business. Also, prior attempts do not take into account some special considerations and circumstances that are involved in partnering with an entity involved, at least partially, in selling software.

### BRIEF SUMMARY

In an example, a system may comprise a processor and a memory device. The system may further comprise a first module stored in the memory device and executable by the processor to receive a reseller input representative of a cost related to a reseller selling a product of a selling partner and a cost assumption input representative of a cost related to buying the product from the selling partner and generate a reseller output as a function of the reseller input, the reseller output related to a cost of the reseller. The system may further comprise a report module, stored in the memory device and executable by the processor, to receive the reseller output and the cost assumption input and to generate a report output as a function of the reseller output and cost assumption input, the report output comprising a return on partnership investment.

In an example, a method may comprise receiving a reseller input and a cost assumption input, the reseller input comprising a cost related to a reseller selling a product purchased from a selling partner and the cost assumption input comprising a cost related to buying the product from the selling partner. The method may further comprise generating a reseller output as a function of the reseller input, and generating, by executing instructions on a processor of a computing device, a report output as a function of the reseller output and the cost assumption input, the report output comprising a return on partnership investment.

### BRIEF DESCRIPTION OF THE DRAWINGS

Aspects of the present disclosure are illustrated by way of example are not limited by the accompanying figures with like references indicating like elements.

FIG. 1 is a block diagram of a return on partnership investment calculator according to an example embodiment.

FIG. 2 is a block diagram of a return on partnership investment calculator according to an example embodiment.

FIG. 3 is a block diagram of a reseller assumption module according to an example embodiment.

FIG. 4 is a block diagram of an influencer assumption module according to an example embodiment.

FIG. 5 is a block diagram of a report module according to an example embodiment.

FIG. 6 is a flow diagram of a method according to an example embodiment.

FIG. 7 is a block diagram of a user interface according to an example embodiment.

FIG. 8 is a block diagram of a computer system according to an example embodiment.

### DETAILED DESCRIPTION

As will be appreciated by one skilled in the art, aspects of the present disclosure may be illustrated and described herein in any of a number of patentable classes or context comprising any new and useful process, machine, manufacture, or composition of matter, or any new and useful improvement thereof. Accordingly, aspects of the present disclosure may be implemented entirely in hardware, entirely in software (comprising firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may comprise a propagated data signal with computer readable program code embodied therein, for example, in baseband or as part of a carrier wave. Such a propagated signal may take any of a variety of forms, comprising, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, comprising but not limited to wireless, wireline, optical fiber cable, RF, etc., or any suitable combination of the foregoing.

Computer program code for carrying out operations for aspects of the present disclosure may be written in any combination of one or more programming languages, comprising an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, comprising a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture comprising instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

A return on partnership investment calculator may be based on a model of two partners working together and operates to generate financial projections of how the relationship will transpire over a period. For example, the return on partnership investment calculator operates to receive inputs detailing a proposed relationship, products, services and assumption of the relationship from which revenue streams and profit/loss are projected, among other possible financial report outputs. In an example model a reseller buys products and/or services from a selling partner. For example, the selling partner may be a developer of a software product that is marketed, sold, supported, and maintained. The software product may be sufficiently complicated such that education on how to use the software is desired. A reseller may sell products and/or services, maintenance, support, and education to its own clients. Products/services being sold may comprise software, maintenance for the software, education on how to utilize the software, and marketing services related to the software, among others. An example partnership model may comprise a referring partner that refers a purchaser (e.g. customer) to the reseller. In an example, the referring partner influences a customer to buy a product of a selling partner from a reseller. The referring partner that referred the customer to the reselling partner is the referring partner and is contemplated in some embodiments as an influencer.

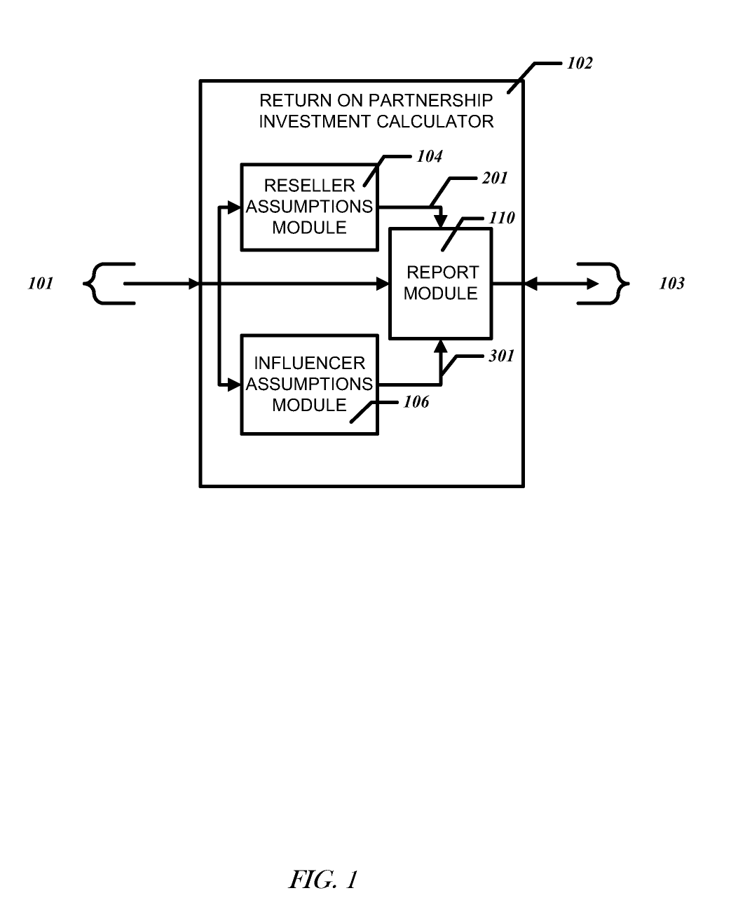

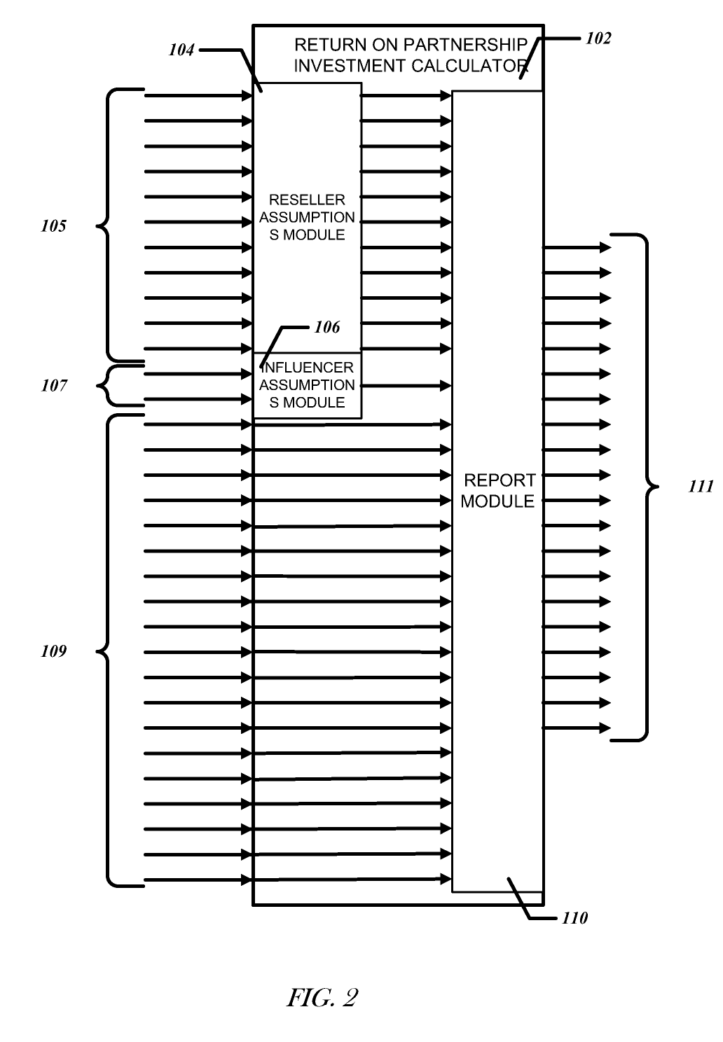

FIG. 1 is a block diagram depiction of a return on partnership investment calculator 102 according to an example embodiment. A return on partnership investment calculator may comprise an input 101, a reseller assumption module 104, an influencer assumption module 106, a report module 110, and an output 103. Input 101 may be coupled to reseller assumption module 104, influencer assumption module 106, and/or report module 110. Input 101 may be used by reseller assumption module 104, influencer assumption module 106, and/or report module 110 to generate output 103. Input 101 may be relevant to a financial outlook of a partnership between two partners. In an example, input 101 is relevant to expected financial growth of a partner and/or revenue generated by a partnership between two partners. In an example, input 101 is relevant to one of product revenue, maintenance and support revenue, education revenue, and services revenue. In an example, reseller assumption module 104 generates a reseller output 201 as a function of input 101 and report module 110 generates output 103 as a function of reseller output 201. In an example, influencer assumption module 106 generates an influencer output 301 as a function of input 101 and report module 110 generates output 103 as a function of influencer output 301. Output 103 may be relevant to revenue generated by a partnership between two partners. Input 101 may comprise a reseller input 105, an influencer input 107, and/or a cost assumption input 109 (see FIG. 2). Output 103 may comprise a report output 111 (see FIG. 2).

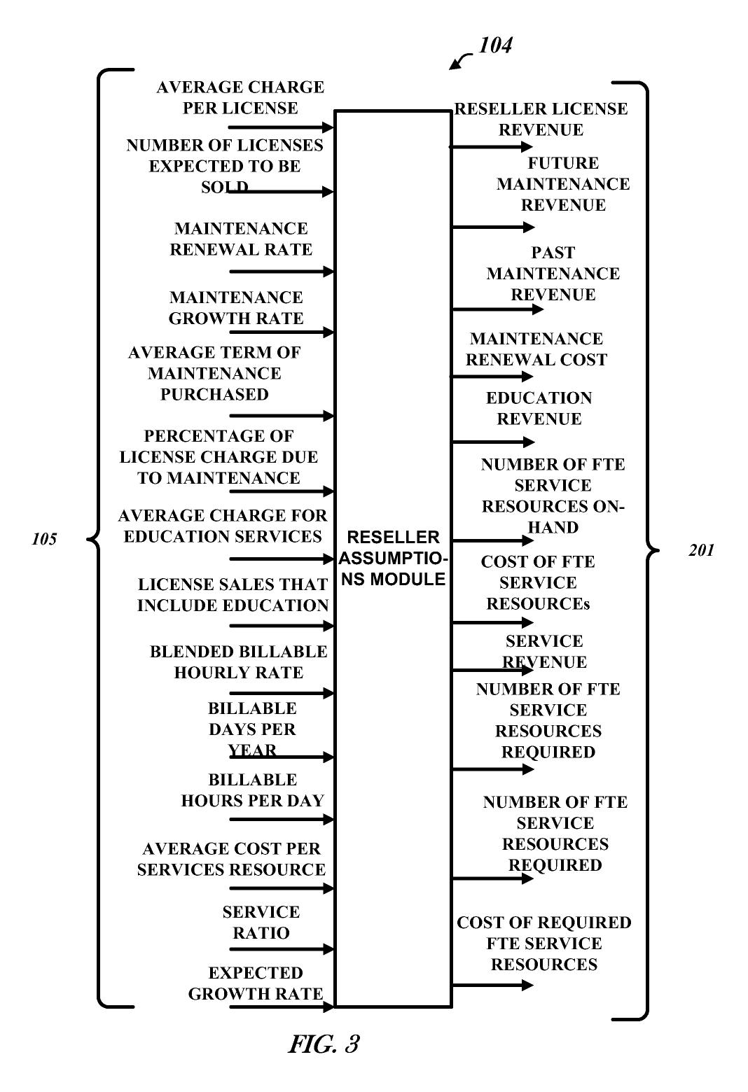

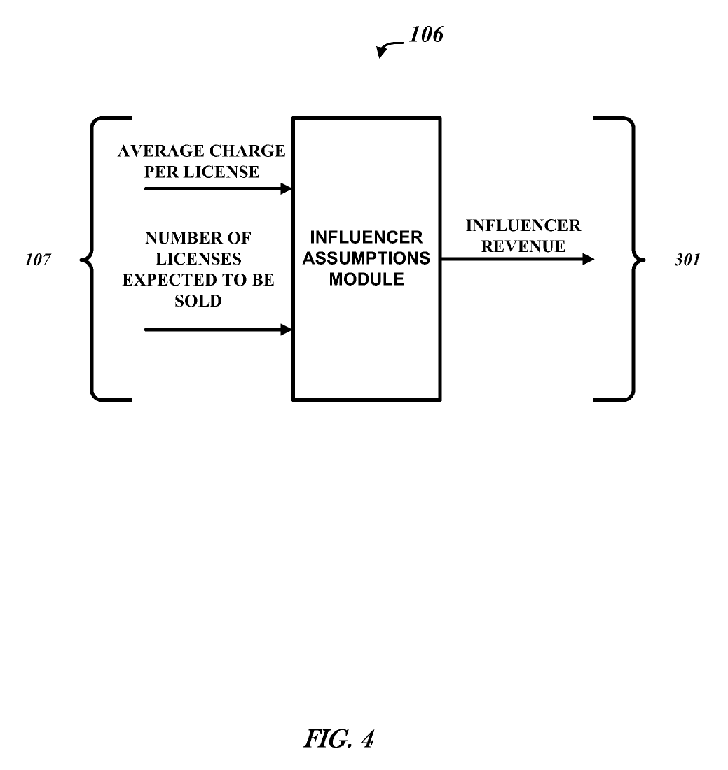

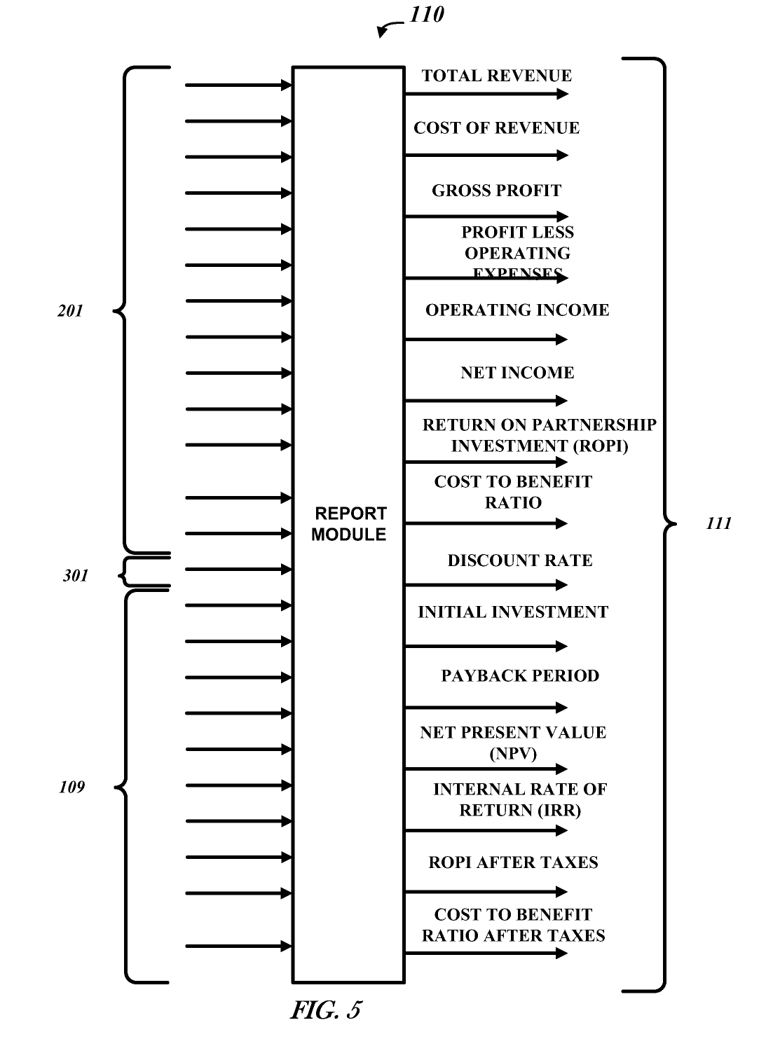

FIG. 2 is a block diagram depiction of the return on partnership investment calculator 102 according to an example embodiment. The return on partnership investment calculator 102 may comprise the reseller assumption module 104, the influencer assumption module 106, and the report module 110. The reseller assumption module 104 may comprise a reseller input 105 and a reseller output 201 (see FIG. 3). The influencer assumption module 106 may comprise an influencer input 107 and an influencer output 301 (see FIG. 4). The report module 110 may comprise an input corresponding to reseller output 201, influencer output 301, and/or cost assumption input 109 (see FIG. 5). Report module 110 may comprise a report output 111.

Return on partnership investment calculator 102 may comprise a reseller input 105. A reseller input 105 may be representative of a cost or prediction related to purchasing a product from a selling partner. A cost or prediction may be relevant to purchasing a product, maintaining and supporting a product, educating personnel how to use a product, and other services to be provided by a reseller or selling partner. Return on partnership investment calculator 102 may comprise an influencer input 107. An influencer input 107 may be representative of an influencer's cost related to influencing a customer to buy a product from a reseller. Return on partnership investment calculator 102 may comprise a cost assumption input 109. A cost assumption input may be representative of a cost or prediction related to buying and/or maintaining a product/service.

A reseller input 105 and a cost assumption input 109 may be input into a module (not shown). The module may generate a reseller output as a function of a reseller input 105.

FIG. 3 is a block diagram depiction of a reseller assumption module 104 according to an example embodiment. A reseller assumption module 104 may be operable to receive a reseller input 105 and produce a reseller output 201. A reseller input 105 may comprise an average charge per license sold by a reseller. The license may be a perpetual license. An average charge per license may be three separate reseller inputs: an average charge per license for a relatively small sized deal, an average charge per license for a relatively medium sized deal, and an average charge per license for a relatively large sized deal. A reseller input may comprise a number of licenses expected to be sold. The number of licenses expected to be sold may be three separate reseller inputs: a number of licenses expected to be sold for a relatively small deal, a number of licenses expected to be sold for a medium sized deal, and a number of licenses expected to be sold for a relatively large sized deal. The number of licenses expected to be sold for relatively small, medium, and large deals may each comprise a separate input for each of a number of years into the future. For example there may be a reseller input for each of an expected number of small deal licenses to be sold for each of the first, second, third, fourth, and fifth year of a partnership. Any number of years into the future may be accommodated. There may be similar inputs for the number of expected licenses to be sold in a medium sized deal, and expected number of licenses to be sold in a large sized deal. A reseller input may comprise an expected growth rate of a partner. The expected growth rate may be expressed as a percentage.

A reseller input 105 may comprise a historical revenue gained from selling maintenance of a product comprising number of past years of selling the product, a renewal rate related to the cost of renewing maintenance on the product, historical growth rate (year over year), an average term of maintenance being sold, and an average amount of a license charge from maintenance of a product. The renewal rate is a percentage of maintenance deals that get “re-upped” when a maintenance term terminates. The historical growth rate may be expressed as a percentage. The historical growth rate may be the historical growth rate of selling maintenance on products.

A reseller input 105 may comprise an input related to selling education for using a product. A reseller input 105 may comprise an average education deal size. The average education deal size may comprise an average education deal size for a relatively small, medium, and large deal. A reseller input 105 may comprise a percentage of deals that comprise a sale of education to use a product. The percentage of deals that comprise a sale of education to use a product may comprise a percentage of relatively small deals, medium deals, and large deals that comprise the sale of education to use a product.

A reseller input 105 may comprise an input related to servicing a product. A reseller input 105 may comprise a blended billable hourly rate. The blended billable hourly rate may be an average hourly rate of all personnel required to service a product. A reseller input 105 may comprise an average number of billable days per year, a number of average billable hours per day, and a standard annual cost per services resource. A reseller input 105 may comprise service revenue to perpetual license revenue ratio. The service revenue to perpetual license revenue ratio may comprise service revenue to perpetual license revenue ratio for a relatively small sized deal, medium sized deal, and large sized deal.

Reseller assumption module 104 may comprise a reseller output 201. A reseller output 201 may comprise reseller license revenue. The reseller license revenue may comprise reseller license revenue for each of the next five years. The reseller license revenue may comprise reseller license revenue for a relatively small sized deal, a medium sized deal and a large sized deal.

A reseller output 201 may comprise future maintenance revenue. Future maintenance revenue may comprise future maintenance revenue for a relatively small sized deal, medium sized deal, and large sized deal. Future maintenance revenue may further comprise maintenance revenue for each of the next five years. A reseller output 201 may comprise past maintenance revenue. Past maintenance revenue may comprise past maintenance revenue for a relatively small sized deal, medium sized deal, and large sized deal. Past maintenance revenue may comprise past maintenance revenue for each of the past five years, if relevant. A reseller output 201 may comprise maintenance renewal revenue. Maintenance renewal revenue may comprise maintenance renewal revenue for a relatively small sized deal, medium sized deal, and large sized deal. The maintenance renewal revenue may comprise maintenance renewal revenue for each of the next five years.

The reseller output 201 may comprise education revenue. Education revenue may comprise education revenue for a relatively small sized deal, medium sized deal, and large sized deal. The education revenue may comprise education revenue for each of the next five years.

A reseller output 201 may comprise an output related to servicing a product. A reseller output 201 may comprise a number of service full-time employees (FTE) on-hand. The service FTE on-hand output may be generated as a function of annual billable days per resource. The service FTE on-hand may comprise service FTE required for each of the next three years. A reseller output 201 may comprise service FTE resource cost per year. The service FTE resource cost per year may comprise service FTE resource cost per year for each of the next three years. A reseller output 201 may comprise service revenue. The service revenue may comprise service revenue for a relatively small sized deal, medium sized deal, and large sized deal. Service revenue may comprise service revenue for each of the next five years. A reseller output 201 may comprise service FTE required. Service FTE required may comprise service FTE required for a relatively small sized deal, medium sized deal, and large sized deal. The service FTE required may comprise service FTE required for each of the next five years. A reseller output 201 may comprise service FTE resource cost. Service FTE resource cost may comprise service FTE resource cost for a relatively small sized deal, medium sized deal, and large sized deal. The Service FTE resource cost may comprise service FTE resource cost for each of the next five years.

FIG. 4 is a block diagram depiction of an influencer assumption module 106 according to an example embodiment. An influencer assumption module 106 may comprise an influencer input 107 and an influencer output 301. An influencer input 107 may comprise a cost related to influencing a customer to buy a product. An influencer output 301 may be generated as a function of an influencer input 107. An influencer output 301 may be relevant to an influencer's expected revenue. An influencer input 107 may comprise average charge per license influenced. The license influenced may be perpetual. The average charge per license influenced may comprise an average charge per license influenced for a relatively small sized deal, medium sized deal, and large sized deal. An influencer input 107 may comprise number of licenses expected to be sold. The number of licenses expected to be sold may comprise a number of licenses expected to be sold for a relatively small sized deal, medium sized deal, and large sized deal. The number of licenses expected to be sold may comprise a number of licenses expected to be sold for each of the next five years. An influencer output 301 may comprise influencer revenue. The influencer revenue may comprise influencer revenue for a relatively small sized deal, medium sized deal, and large sized deal. The influencer revenue may comprise influencer revenue for each of the next five years.

FIG. 5 is a block diagram depiction of a report module 110 according to an example embodiment. Report module 110 may comprise a report input corresponding to a reseller output 201, an influencer output 301, and/or a cost assumption input 109. Report module 110 may comprise a report output 111. A report output 111 may comprise data relevant to a cost associated with a reseller partnering with the selling partner. A report output 111 may comprise data relevant to a cost associated with an influencer partnering with a partner.

A cost assumption input 109 may comprise gross profit on licenses sold. Gross profit may be generated as a function of a cost assumption input comprising a list price of a product, a discount granted to a customer in a reseller selling the product, and a reseller purchase discount from the list price. The reseller purchase discount from the list price may be expressed as a percentage. A cost assumption input 109 may comprise an annual cost of training a sales resource. A cost assumption input 109 may comprise an average fully-loaded compensation cost for a sales resource. A cost assumption input 109 may comprise an expected FTE sales resource count. The expected FTE sales resource count may comprise expected sales resource count for each of the next five years.

A cost assumption input 109 may comprise a gross profit from maintenance. Gross profit from maintenance may comprise a maintenance list price, a discount on maintenance to the customer, and a reseller discount from maintenance list price. A cost assumption input 109 may comprise a gross profit from a renewal. The gross profit from a renewal may comprise a renewal list price, a discount on renewal to the customer, and a reseller discount from renewal list price. A cost assumption input 109 may comprise an annual cost of training a maintenance support resource. A cost assumption input 109 may comprise an average fully-loaded compensation cost for a maintenance support resource. A cost assumption input 109 may comprise an expected FTE maintenance support resource count. The expected FTE maintenance support resource count may comprise an expected FTE maintenance support resource count for each of the next five years. A cost assumption input 109 may comprise cost per unit of maintenance support expenditures. A cost assumption input 109 may comprise the number of maintenance support units expected to be sold. The number of maintenance support units expected to be sold may comprise the number of maintenance support units expected to be sold for each of the next five years.

A cost assumption input 109 may comprise a cost per market expenditure unit. A cost assumption input 109 may comprise an expected number of marketing expenditure units to be sold. The expected number of marketing expenditure units to be sold may comprise an expected number of marketing expenditure units to be sold for each of the next five years.

A cost assumption input 109 may comprise a gross profit from education. Gross profit from education may comprise an education list price, a discount on education to the customer, and a reseller discount from education list price. A cost assumption input 109 may comprise an annual cost of training an education resource. A cost assumption input 109 may comprise an average fully-loaded compensation cost for an education resource. A cost assumption input 109 may comprise an expected FTE education resource count. The expected FTE education resource count may comprise an expected FTE education resource count for each of the next five years. A cost assumption input 109 may comprise cost per unit of education expenditure. A cost assumption input 109 may comprise the number of education units expected to be sold. The number of education units expected to be sold may comprise the number of education units expected to be sold for each of the next five years.

A cost assumption input 109 may comprise a financial metric. The financial metric may comprise a current cost of capital. The current cost of capital may be expressed as a percentage. A financial metric may comprise a current tax rate. The current tax rate may be expressed as a percentage.

A cost assumption input 109 may comprise a partner incentive input. A partner incentive input may comprise an annual rebate amount received from a partner selling a product. The annual rebate may be expressed as a percentage. A partner incentive input may comprise an influencer fee rebate. The influencer fee rebate may be expressed as a percentage.

Report module 110 may comprise a report output 111. A report output 111 may be relevant to a cost of a reseller. A report output 111 may be relevant to a cost of an influencer. A report output 111 may comprise an output relevant to a forecasted profit and loss report. The forecasted profit and loss report may comprise a forecasted output comprising a total revenue, cost of revenue, gross profit, profit less operating expenses, operating income, and net income after taxes. Any of the forecasted outputs may comprise a corresponding forecasted output for each of the next five years and/or a forecasted total. Total revenue may be generated as a function of a cost assumption input 109, reseller input 105, reseller output 201, influencer input 107, and/or influencer output 301 (referred to collectively as “ROPI I/O”). Total revenue may be generated as a function of product revenue, maintenance revenue, renewal revenue, education revenue, influencer referral revenue, and/or services revenue. Cost of revenue may be generated as a function of ROPI I/O. Cost of revenue may be generated as a function of product license cost, product cost rebate, maintenance resource cost, maintenance license cost, renewal maintenance license cost, education resource cost, and/or services resource cost. Gross profit may be generated as a function of ROPI I/O. Gross profit may be generated as a function of total revenue and cost of revenue. Gross profit may be expressed as a percentage. Profit less operating expenses may comprise ROPI I/O. Profit less operating expenses may be generated as a function of selling resource expense, marketing expense, maintenance support expense, and education expense. Operating income may be generated as a function of ROPI I/O. Operating income may be generated as a function of total revenue, cost of revenue, gross profit, and profit less operating expense. Net income after taxes may be generated as a function of ROPI I/O. Net income after taxes may be generated as a function of operating income and current tax rate.

A report output 111 may comprise an output relevant to a reported financial metric. A reported financial metric may comprise a return on partnership investment (ROPI), cost to benefit ratio, discount rate, initial investment, payback period, net present value (NPV), internal rate of return (IRR), ROPI after taxes, and/or cost to benefit ratio after taxes.

Report module 110 may generate graphical and other representations. In an example, report module 110 generates a table of values, the values generated as a function of a of ROPI I/O and/or report outputs 111. In an example report module generates a graph. The graph may be any one of a bar graph, column graph, line graph, pie graph, scatter plot, or any other type of graph. The graph may be generated as a function of ROPI I/O and/or report outputs 111.

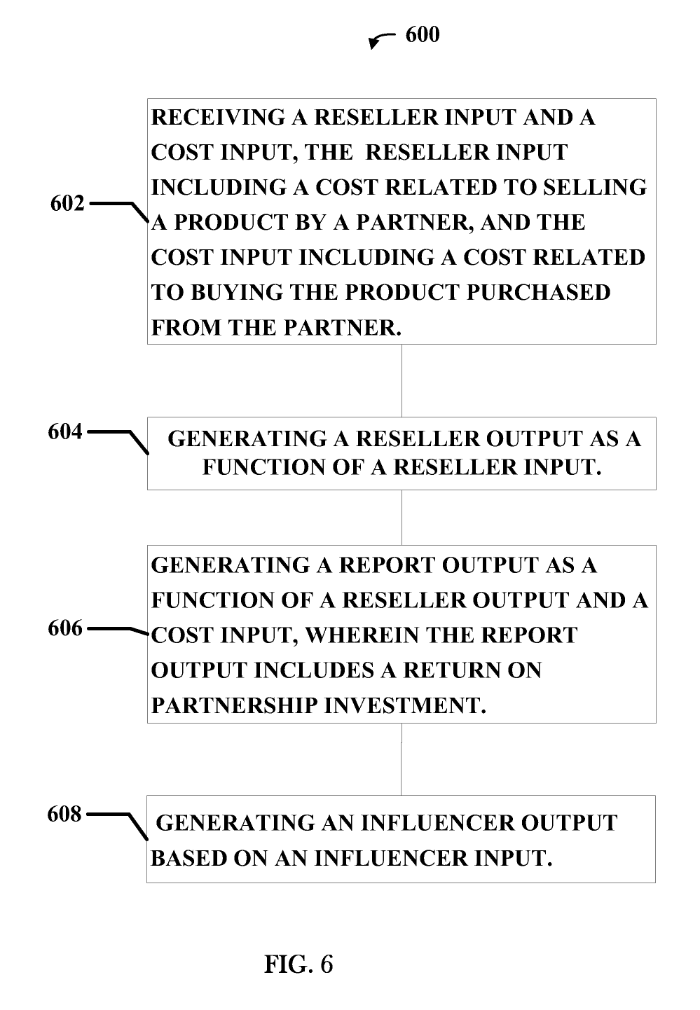

FIG. 6 is a flow diagram of a method 600 according to an example embodiment. Method 600 begins at 602 with receiving a reseller input and a cost assumption input. A reseller input may comprise a cost related to a reseller selling a product. A cost assumption input may comprise a cost related to buying the product from a selling partner. At 604 a reseller output is generated as a function of a reseller input. At 606 a report output is generated as a function of a reseller and/or cost assumption input. In an example, a report output may comprise a return on partnership investment. In another example, a report output may comprise a financial report. The financial report may comprise a profit and loss report. In another example, the report output may comprise a prospective cost and profit projection for a number of defined periods. The defined periods may be quarters, years, decades, or any other desired time interval.

At 608 an influencer input is received. The influencer input may comprise a cost related to influencing a customer to buy a product of a selling partner. At 610 an influencer output is generated as a function of the influencer input. At 612 a report output is generated as a function of the influencer output.

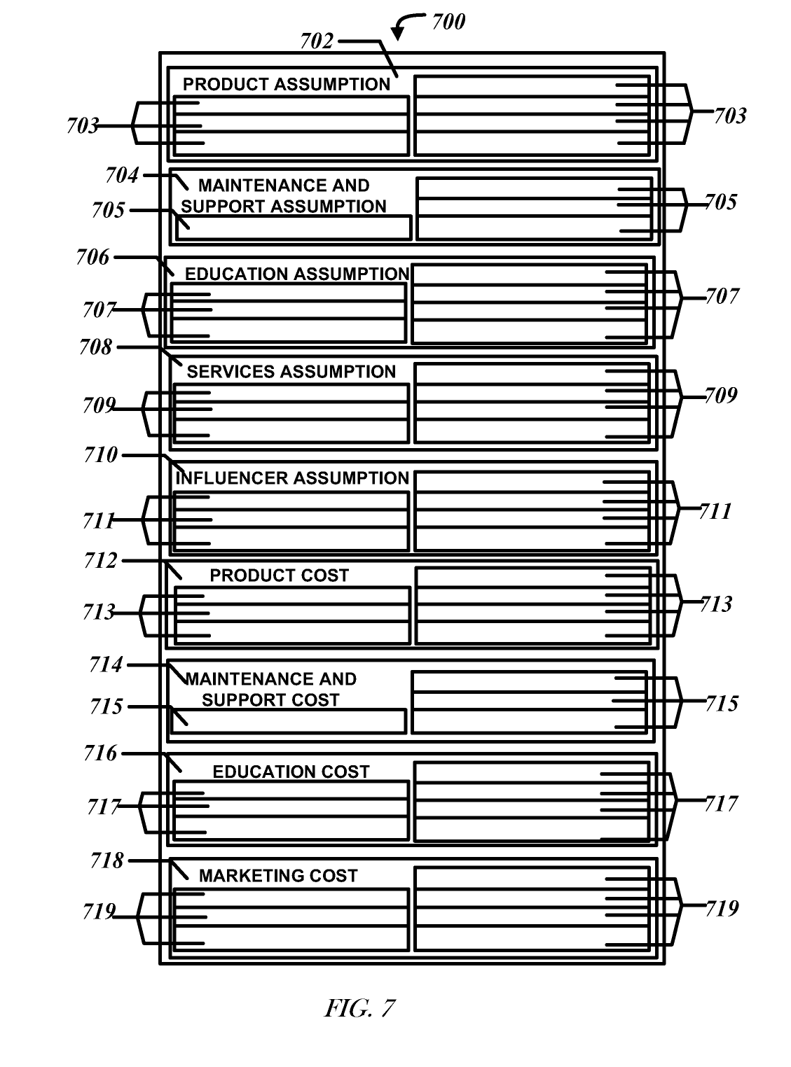

FIG. 7 is a block diagram of a user interface 700 that may be used with a computer system according to an example embodiment. Although the user interface 700 is illustrated as a single user interface, the user interface 700 may be divided across multiple user interfaces in some embodiments. User interface 700 may include an input module. An input module may facilitate communication of an input to computer from a user. The input may be received through a keyboard and mouse, a touch screen, or any other method of entering data into a computer console. An input module may be a product assumption input module 702, a maintenance and support assumption input module 704, an education assumption input module 706, a services assumption input module 708, an influencer input module 710, a product cost input module 712, a maintenance and support cost module 714, an education cost module 716, and/or a marketing cost module 718.

A product assumption input module 702 may include a product assumption input field 703. The data input into a product assumption input field 703 may be representative of a cost or prediction relevant to a reseller selling a product or service to a customer. Reseller input 105 may include data input into a product assumption input field 703.

A maintenance and support assumption input module 704 may include a maintenance and support assumption input field 705. The data input into a maintenance and support assumption input field 705 may be representative of a cost or prediction relevant to a reseller selling maintenance and support to a customer. Reseller input 105 may include data input into a maintenance and support assumption input field 705.

An education assumption input module 706 may include an education assumption input field 707. The data input into an education assumption input field 707 may be representative of a cost or prediction relevant to a reseller selling education services to a customer. Reseller input 105 may include data input into an education assumption input field 707.

A services assumption input module 708 may include a services assumption input field 709. The data input into a product assumption input field 709 may be representative of a cost or prediction relevant to a reseller selling services to a customer. Reseller input 105 may include data input into a services assumption input field 709.

An influencer input module 710 may include an influencer input field 711. The data input into an influencer input field 711 may be representative of a cost or prediction relevant to an influencer influencing a customer to purchase a product. Influencer input 107 may include data input into a product assumption input field 711.

A product cost input module 712 may include a product cost input field 713. The data input into a product cost input field 713 may be representative of a cost or prediction relevant to a reseller purchasing a product or service from a selling partner. Cost assumption input 109 may include data input into a product cost input field 713.

A maintenance and support cost input module 714 may include a maintenance and support cost input field 715. The data input into a maintenance and support cost input field 715 may be representative of a cost or prediction relevant to a reseller providing maintenance and support to a customer. Cost assumption input 109 may include data input into a maintenance and support cost input field 715.

An education cost input module 716 may include an education cost input field 717. The data input into an education cost input field 717 may be representative of a cost or prediction relevant to a reseller providing education for a customer. Cost assumption input 109 may include data input into an education cost input field 717.

A marketing cost input module 718 may include a marketing cost input field 719. The data input into a marketing cost input field 719 may be representative of a cost or prediction relevant to a reseller marketing a product or service to a customer. Cost assumption input 109 may include data input into an education cost input field 719.

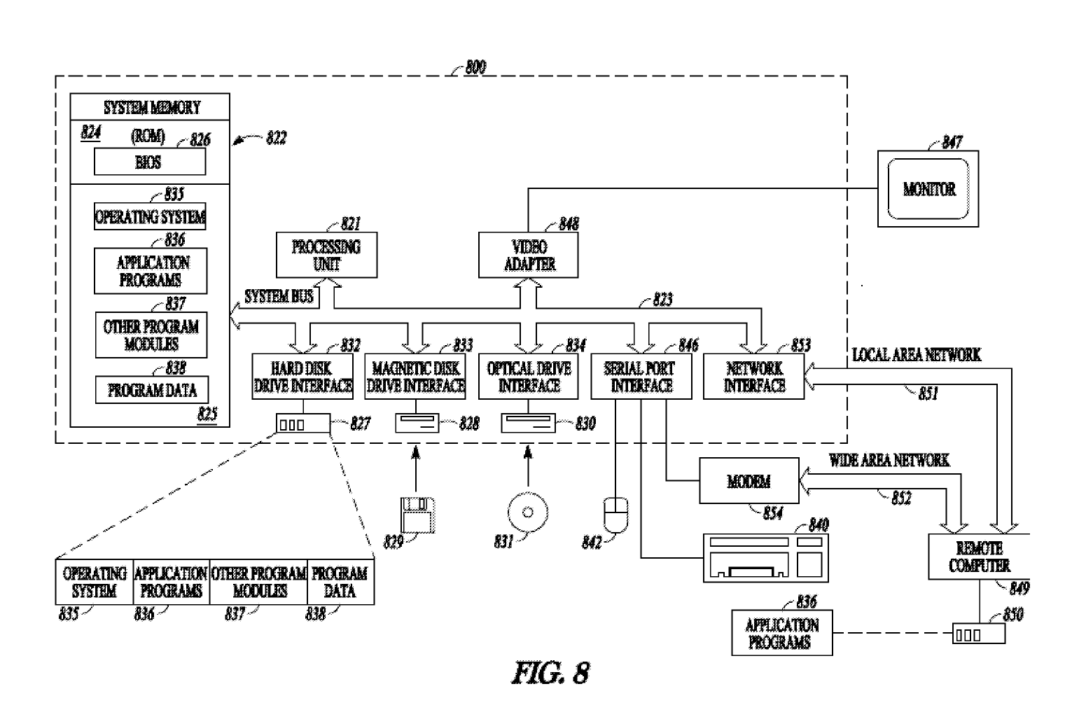

FIG. 8 is a block diagram of a computer system to implement methods according to an example embodiment. In the embodiment shown in FIG. 8, a hardware and operating environment is provided that is applicable to any of the servers and/or remote clients shown in the other Figures.

As shown in FIG. 8, one embodiment of the hardware and operating environment comprises a general purpose computing device in the form of a computer 800 (e.g., a personal computer, workstation, or server), comprising one or more processing units 821, a system memory 822, and a system bus 823 that operatively couples various system components comprising the system memory 822 to the processing unit 821. There may be only one or there may be more than one processing unit 821, such that the processor of computer 800 comprises a single central-processing unit (CPU), or a plurality of processing units, commonly referred to as a multiprocessor or parallel-processor environment. In various embodiments, computer 800 is a conventional computer, a distributed computer, or any other type of computer.

The system bus 823 can be any of several types of bus structures comprising a memory bus or memory controller, a peripheral bus, and a local bus using any of a variety of bus architectures. The system memory can also be referred to as simply the memory, and, in some embodiments, comprises read-only memory (ROM) 824 and random-access memory (RAM) 825. A basic input/output system (BIOS) program 826, containing the basic routines that help to transfer information between elements within the computer 800, such as during start-up, may be stored in ROM 824. The computer 800 further comprises a hard disk drive 827 for reading from and writing to a hard disk, not shown, a magnetic disk drive 828 for reading from or writing to a removable magnetic disk 829, and an optical disk drive 830 for reading from or writing to a removable optical disk 831 such as a CD ROM or other optical media.

The hard disk drive 827, magnetic disk drive 828, and optical disk drive 830 couple with a hard disk drive interface 832, a magnetic disk drive interface 833, and an optical disk drive interface 834, respectively. The drives and their associated computer-readable media provide non volatile storage of computer-readable instructions, data structures, program modules and other data for the computer 800. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 829, optical disk 831, ROM 824, or RAM 825, comprising an operating system 835, one or more application programs 836, other program modules 837, and program data 838. Programming for implementing one or more processes or method described herein may be resident on any one or number of these computer-readable media.

A user may enter commands and information into computer 800 through input devices such as a keyboard 840 and pointing device 842. Other input devices (not shown) can comprise a microphone, joystick, game pad, satellite dish, scanner, or the like. These other input devices are often connected to the processing unit 821 through a serial port interface 846 that is coupled to the system bus 823, but can be connected by other interfaces, such as a parallel port, game port, or a universal serial bus (USB). A monitor 847 or other type of display device can also be connected to the system bus 823 via an interface, such as a video adapter 848. The monitor 847 can display a graphical user interface for the user. In addition to the monitor 847, computers typically comprise other peripheral output devices (not shown), such as speakers and printers.

The computer 800 may operate in a networked environment using logical connections to one or more remote computers or servers, such as remote computer 849. These logical connections are achieved by a communication device coupled to or a part of the computer 800; the invention is not limited to a particular type of communications device. The remote computer 849 can be another computer, a server, a router, a network PC, a client, a peer device or other common network node, and typically comprises many or all of the elements described above I/O relative to the computer 800, although only a memory storage device 850 has been illustrated. The logical connections depicted in FIG. 8 comprise a local area network (LAN) 851 and/or a wide area network (WAN) 852. Such networking environments are commonplace in office networks, enterprise-wide computer networks, intranets and the internet, which are all types of networks.

When used in a LAN-networking environment, the computer 800 is connected to the LAN 851 through a network interface or adapter 853, which is one type of communications device. In some embodiments, when used in a WAN-networking environment, the computer 800 typically comprises a modem 854 (another type of communications device) or any other type of communications device, e.g., a wireless transceiver, for establishing communications over the wide-area network 852, such as the internet. The modem 854, which may be internal or external, is connected to the system bus 823 via the serial port interface 846. In a networked environment, program modules depicted relative to the computer 800 can be stored in the remote memory storage device 850 of remote computer, or server 849. It is appreciated that the network connections shown are exemplary and other means of, and communications devices for, establishing a communications link between the computers may be used comprising hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The terminology used herein is for the purpose of describing particular aspects only and is not intended to be limiting of the disclosure. As used herein, the singular forms “a”, “an” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to explain the principles of the disclosure and the practical application, and to enable others of ordinary skill in the art to understand the disclosure with various modifications as are suited to the particular use contemplated.

1. A system comprising:
a processor;
a memory device;
a first module stored in the memory device and executable by the processor to:
receive a reseller input representative of a cost related to a reseller selling a product of a selling partner and a cost assumption input representative of a cost related to buying the product from the selling partner; and
generate a reseller output as a function of the reseller input, the reseller output related to a cost of the reseller; and
a report module, stored in the memory device and executable by the processor, to receive the reseller output and the cost assumption input and to generate a report output as a function of the reseller output and cost assumption input, the report output comprising a return on partnership investment.

2. The system of claim 1, further comprising:
an influencer assumption module, stored in the memory device and executable by the processor, to receive an influencer input and to generate an influencer output as a function of the influencer input, the influencer input comprising a cost related to influencing a customer to buy the product of the selling partner from the reseller, and wherein the report output comprises an output generated as a function of the influencer output.

3. The system of claim 1, wherein the report output comprises a financial report.

4. The system of claim 3, wherein the financial report output comprises a profit and loss report.

5. The system of claim 3, wherein the report output comprises a prospective cost and profit projection for a number of defined periods.

6. The system of claim 1, wherein the reseller input comprises a predicted growth rate of reseller sales of the product.

7. The system of claim 1, wherein the cost assumption input comprises a gross profit from selling the product.

8. A method comprising:
receiving a reseller input and a cost assumption input, the reseller input comprising a cost related to a reseller selling a product purchased from a selling partner and the cost assumption input comprising a cost related to buying the product from the selling partner;
generating a reseller output as a function of the reseller input; and
generating, by executing instructions on a processor of a computing device, a report output as a function of the reseller output and the cost assumption input, the report output comprising a return on partnership investment.

9. The method of claim 8, further comprising:
receiving an influencer input, wherein the influencer input comprises a cost related to influencing a customer to buy the product from the reseller;
generating an influencer output as a function of the influencer input; and
wherein a report output is generated as a function of the influencer output.

10. The method of claim 8, wherein the report output comprises a financial report.

11. The method of claim 9, wherein the financial report comprises a profit and loss report.

12. The method of claim 10, wherein the report output comprises a prospective cost and profit projection for a number of defined periods.

13. The method of claim 8, wherein the reseller input further comprises an expected growth rate of sales of the product.

14. The method of claim 8, wherein the cost assumption input further comprises an expected gross profit from selling the product.

15. A computer program product comprising:
a computer readable storage medium having computer readable program code embodied therewith, the computer program code comprising:
computer readable program code configured to receive a reseller input and a cost assumption input, the reseller input comprising a cost related to a reseller selling a product purchased from a selling partner and the cost assumption input comprising a cost related to buying the product from the selling partner;
computer readable program code configured to generate a reseller output as a function of the reseller input; and
computer readable program code configured to generate, by executing instructions on a processor of a computing device, a report output as a function of the reseller output and the cost assumption input, the report output comprising a return on partnership investment.

16. The computer program product of claim 15, wherein the computer program code further comprises:
computer readable program code configured to receive an influencer input, wherein the influencer input comprises a cost related to influencing a customer to buy the product from the reseller;
computer readable program code configured to generate an influencer output as a function of the influencer input; and
wherein a report output is generated as a function of the influencer output.

17. The computer program product of claim 16, wherein the report output comprises a financial report.

18. The computer program product of claim 17, wherein the financial report comprises a profit and loss report.

19. The computer program product of claim 16, wherein the report output comprises a prospective cost and profit projection for a number of defined periods.

20. The computer program product of claim 15, wherein the cost assumption input further comprises an expected gross profit from selling the product.
